(19) United States
(12) Patent Application Publication
(10) Pub. No.: US 2021/0248531 A1
(43) Pub. Date: Aug. 12, 2021

(54) CONSTRAINT PLANNER ENGINE

(71) Applicant: NextWorld LLC, Denver, CO (US)

(72) Inventors: Axel Allgeier, Denver, CO (US); Luke Hollenback, Denver, CO (US)

(21) Appl. No.: 16/817,936

(22) Filed: Mar. 13, 2020

Related U.S. Application Data
(60) Provisional application No. 62/975,563, filed on Feb. 12, 2020.

(51) Int. Cl. G06Q 10/06; G06Q 10/10; G06N 5/04; G06N 20/00

(52) U.S. Cl. CPC G06Q 10/06313; G06N 20/00; G06N 5/04; G06Q 10/109

(57) ABSTRACT

Various embodiments of the present technology generally relate to a constraint-based planning system. More specifically, some embodiments relate to a generic, scalable planning engine that may integrate into existing enterprise resource planning software. In one embodiment, a method of comprises initiating a planner engine on a computer according to a planner definition, wherein the planner definition identifies a planning problem and includes metadata identifying planning variables and constraints. The method further comprises gathering data from a database specified by the planner definition, parsing the data into planning data, and solving the planning problem based on the one or more constraints. The method further comprises identifying a final plan based on how well it satisfies the one or more constraints compared to at least one other plan and ultimately outputting the final plan.

### CROSS-REFERENCE TO RELATED APPLICATIONS

This application claims priority to U.S. Provisional Application Ser. No. 62/975,563 filed Feb. 12, 2020, which is incorporated herein by reference in its entirety for all purposes.

### BACKGROUND

Enterprise resource planning (ERP) software provides mechanisms for company personnel to plan and manage various resources associated with the company's business from one or more applications. Aspects of a business that can be tracked or otherwise managed utilizing ERP software include sales management, scheduling, optimization, production planning, manufacturing or service delivery, marketing, materials management, inventory management, retail, shipping and payment, financials, and many more. Although ERP software can be tailored to a company based on a particular application or application suite that the company utilizes, the specific mechanics included in such applications or application suites may include superfluous features and/or there may be certain features that company personnel would like, but which nonetheless do not exist in currently available software packages. That is, a one size fits all solution in ERP software is difficult and inefficient to apply because the needs and desires of each company are different and often in flux due to a variety of factors.

Scheduling and optimization problems appear in a wide variety of industries and businesses and are an important component of ERP. Scheduling and optimization may be applied to student scheduling, employee scheduling, master production scheduling, bill of materials optimization, and many other applications. However, it is a well-known problem that generating schedules according to the needs, desires, or constraints of each individual student, employee, commodity, or material, as just a few examples, can be extremely difficult and time-consuming.

Constraints are limitations that apply to a particular planning scenario. Constraint-based planning accounts for and attempts to respect constraints that may apply to a scheduling or optimization problem. A supply chain created without consideration of its constraints is impractical and cannot produce a feasible plan. Individual constraints are often categorized as hard or soft constraints. Hard constraints take priority over soft constraints and are considered mandatory constraints in some scenarios. This ranking of constraints plays an important role in the optimization process of constraint-based planning.

It is with respect to this general technical environment that aspects of the present technology disclosed herein have been contemplated. Furthermore, although a general environment has been discussed, it should be understood that the examples described herein should not be limited to the general environment identified in the background.

### BRIEF SUMMARY OF THE INVENTION

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Various embodiments of the technology described herein generally relate to a constraint-based planning system (i.e., a planner). More specifically, certain embodiments relate to a generic, scalable planning engine that may integrate into existing enterprise resource planning software. In one embodiment of the present technology, a method of operating a planner engine comprises, in a computer, initiating the planner engine according to a planner definition, wherein the planner definition identifies a planning problem and includes metadata identifying one or more planning variables of the planning problem and one or more constraints related to the one or more planning variables. The method further comprises, in the computer, gathering data from a database specified by the planner definition and parsing the data into planning data based on the planner definition. The method further comprises, in the computer, conducting planning according to the planner definition using the planning data, wherein conducting the planning comprises creating one or more plans by solving the planning problem based on the one or more constraints related to the one or more planning variables, identifying a final plan from the one or more plans, wherein the final plan is identified based on how well the final plan satisfies the one or more constraints compared to at least one other plan of the one or more plans, and outputting the final plan.

In some embodiments, the planner definition further identifies at least one or more of a time constraint, optimal score, heuristic, algorithm, and logic block. Furthermore, in some embodiments, outputting the final plan comprises calling a final logic block specified in the planner definition and passing a representation of final values for each planning variable of the one or more planning variables to the final logic block. Conducting planning according to the planner definition using the planning data may further comprise calculating a hard score, a medium score, and a soft score for at least one planning variable of the one or more planning variables and solving the planning problem based at least in part on the hard score, the medium, score, and the soft score for the at least one planning variable of the one or more planning variables. The computer, in some embodiments, is a server chosen based on computing requirements associated with the planner definition. Additionally, conducting planning according to the planner definition using the planning data may further comprise initiating a constraint solver in multiple threads according to a parallelization method specified in the planner definition wherein the multiple threads solve the planning problem in parallel. In certain embodiments, the planner definition is configured in a planner builder application and the planner builder application receives input from a user specifying data and requirements related to the planning problem.

In an alternative embodiment of the present technology, a planner system comprising one or more computer-readable storage media and a processing system operatively coupled with the one or more computer-readable storage media comprises program instructions stored on the one or more computer-readable storage media for operating a planner engine, wherein the program instructions, when read and executed by the processing system, direct the processing system to at least initiate the planner engine according to a planner definition, wherein the planner definition identifies a planning problem and includes metadata identifying one or more planning variables of the planning problem and one or more constraints related to the one or more planning variables. The program instructions further direct the processing system to gather data from a database specified by the planner definition, parse the data into planning data based on the planner definition, and conduct planning according to the planner definition using the planning data, wherein the planning comprises creating one or more plans by solving the planning problem based on the one or more constraints related to the one or more planning variables. The program instructions further direct the processing system to identify a final plan from the one or more plans, wherein the final plan is identified based on how well the final plan satisfies the one or more constraints compared to at least one other plan of the one or more plans, and output the final plan.

In yet another embodiment of the present technology, one or more computer-readable storage media have program instructions stored thereon for operating a planner engine, wherein the program instructions, when read and executed by a processing system, direct the processing system to, initiate the planner engine according to a planner definition, wherein the planner definition identifies a planning problem and includes metadata identifying one or more planning variables of the planning problem and one or more constraints related to the one or more planning variables. The program instructions further direct the processing system to gather data from a database specified by the planner definition, parse the data into planning data based on the planner definition, and conduct planning according to the planner definition using the planning data, wherein the planning comprises creating one or more plans by solving the planning problem based on the one or more constraints related to the one or more planning variables. The program instructions then direct the processing system to identify a final plan from the one or more plans, wherein the final plan is identified based on how well the final plan satisfies the one or more constraints compared to at least one other plan of the one or more plans, and output the final plan.

### BRIEF DESCRIPTION OF THE DRAWINGS

Many aspects of the disclosure can be better understood with reference to the following drawings. The components in the drawings are not necessarily drawn to scale. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates a design overview of a constraint planner system in accordance with some embodiments of the present technology;

FIG. 2 is a flow chart illustrating a series of planning steps in accordance with some embodiments of the present technology;

FIG. 3 illustrates a visual data example in accordance with some embodiments of the present technology;

FIG. 4 illustrates a constraint planner object diagram in accordance with some embodiments of the present technology;

FIGS. 5A-5N illustrate examples of detailed constraint planner objects in accordance with some embodiments of the present technology;

FIG. 6 illustrates a constraint planner data flow in accordance with some embodiments of the present technology;

FIG. 7 is a flow chart illustrating a series of steps for constraint-based planning in accordance with some embodiments of the present technology;

FIG. 8 illustrates an example of a planner builder application user interface in accordance with some embodiments of the present technology;

FIG. 9 is a flow chart illustrating a series of steps in response to an interaction with the user interface of a planner builder application in accordance with some embodiments of the present technology;

FIGS. 10A-10J illustrate examples of a user interface of a planner definitions application in accordance with some embodiments of the present technology; and

FIG. 11 is an example of a computing system in which some embodiments of the present technology may be utilized.

The drawings have not necessarily been drawn to scale. Similarly, some components or operations may not be separated into different blocks or combined into a single block for the purposes of discussion of some of the embodiments of the present technology. Moreover, while the technology is amendable to various modifications and alternative forms, specific embodiments have been shown by way of example in the drawings and are described in detail below. The intention, however, is not to limit the technology to the particular embodiments described. On the contrary, the technology is intended to cover all modifications, equivalents, and alternatives falling within the scope of the technology as defined by the appended claims.

### DETAILED DESCRIPTION

The following description and associated figures teach the best mode of the invention. For the purpose of teaching inventive principles, some conventional aspects of the best mode may be simplified or omitted. The following claims specify the scope of the invention. Note that some aspects of the best mode may not fall within the scope of the invention as specified by the claims. Thus, those skilled in the art will appreciate variations from the best mode that fall within the scope of the invention. Those skilled in the art will appreciate that the features described below can be combined in various ways to form multiple variations of the invention. As a result, the invention is not limited to the specific examples described below, but only by the claims and their equivalents.

Various embodiments of the technology described herein generally relate to a constraint-based planning system (i.e., a planner). More specifically, certain embodiments relate to a generic, scalable planning engine that may integrate into existing enterprise resource planning (ERP) software. The constraint-based planner of the present disclosure enables application developers to develop solutions that can efficiently and effectively find optimal solutions for anything from student scheduling problems to manufacturing resource problems. A planner in accordance with the present technology may schedule business resources (e.g., student/employees, materials, delivery vessels, etc.) that are subject to realistic constraints and desires (e.g., cost limitations, time limitations, skill levels, requirements, etc.) in an optimized manner given a certain amount of time and computing power.

One example of a common scheduling and optimization problem to which the present technology may apply is student scheduling in education environments. For example, a school may wish to keep students on-track for graduation while also respecting class size requirements and attempting to fulfill each student's personal education interests. In another example, the present technology may be useful for employee scheduling in which a business must fulfill its staffing needs while also attempting to honor the scheduling requests and requirements of its employees. In another example, the present technology may be applied to master production scheduling that requires planning the quantity of a given commodity to produce during a given time period within the constraints of supply, demand, available technicians, cost, and quality requirements. In yet another example, the present technology may be applied to bill of materials optimization in which it may be used for finding the most cost-effective components to use within the constraints of function and quality requirements, cost, and supply. These exemplary applications are provided for purposes of illustrating potential industries to which the present technology applies and should not be used to limit the scope of the technology. Additional applications exist and are anticipated.

The main entry point for an application developer into the planner in accordance with some embodiments of the present technology is a planner definitions application. The planner definitions application allows a user to define a specific planner definition that can then be run by a planning engine. Amongst other things, the planner definitions application allows a developer to define data sources to be consumed by the planner as well as create planner logic blocks to be used by the planner for tasks like scoring plans and outputting a final plan back to the database. When a planner definition is executed, an instance of the planner's planning engine begins turning—this involves spinning up an appropriate server to solve the defined problem, dynamically generating the necessary code (e.g., Java code), gathering the defined data and parsing it into memory, executing planning algorithms, and calling defined logic blocks.

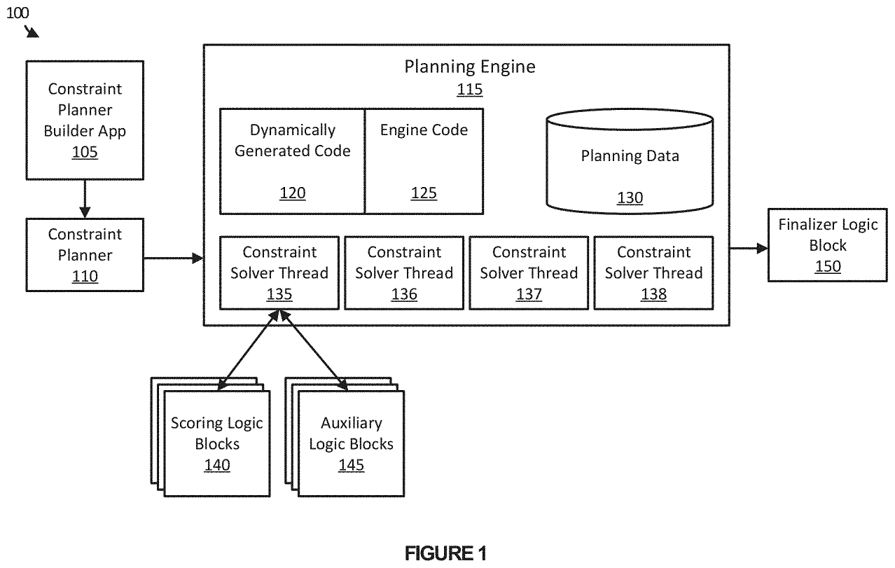

FIG. 1 shows an example of the general design and data flow of the planner in accordance with the present technology. The general design of the planner involves many components that work together, each of which will be described in more detail in reference to the additional figures. Planning environment 100 includes constraint planner builder application 105, constraint planner 110, planning engine 115, scoring logic blocks 140, auxiliary logic blocks 145, and finalizer logic block 150. Planning engine 115 includes dynamically generated code 120, engine code 125, planning data 130, constraint solver thread 135, constraint solver thread 136, constraint solver thread 137, and constraint solver thread 138. The architecture illustrated in planning environment 100 is provided for purposes of example and may vary significantly depending on specific implementations of the technology. Modules, components, order of steps, and groupings may differ and still be in accordance with the present disclosure.

Constraint planner builder application 105 may be used to generate constraint planner 110 according to a specific scenario. Constraint planner builder application 105 (i.e., planner definitions application) is the entry point for an application developer into the planner. Inside the planner definitions application, the developer can fully define a planner definition (i.e., a constraint planner) that can be executed at any time and any number of times to produce planning results. A planner definition is a single record inside of the planner definitions table, upon which the application is built. However, the planner definition has numerous sub tables describing its various aspects.

Examples of things that can be defined by a developer in constraint planner builder application 105 include but are not limited to planning algorithms and heuristics, maximum planner execution times and optimal scores, the table of planning entities (e.g., students, employees, etc.), planning variables (e.g., students' course slots, hours of operation, etc.), data (e.g., offered courses, course requests, time-off requests, etc.), logic blocks for scoring planning variables and packing planning results into the database, and similar information relevant to a planning problem.

When run, constraint planner 110 may then start an instance of planning engine 115. Planning engine 115 runs an on-the-fly server instance catered to the needs of constraint planner 110. When a planner definition is executed, planning engine 115 is executed. Executing planning engine 115 includes a series of steps upon initiation. First, the random-access memory (RAM) and central processing unit (CPU) requirements of a planning server that will run the planner definition are calculated. Based on these specifications, a new server that meets the requirements is spun up and a planner definition which it will execute is identified to the server. The new planning server then pulls the planner definition that it is executing from the database. Once the new planning server has retrieved the planner definition, the server dynamically generates, compiles, and loads code specific to the planner definition (dynamically generated code 120). The server additionally pulls and parses data from the database that the application developer pointed to in the planner definition (i.e., planning data 130 is pulled according to constraint planner metadata and stored in context properties). Once this prep work is complete, the server initiates the integrated constraint solver (e.g., OptaPlanner) and spins the constraint solver off into multiple threads according to a parallelization method specified in the planner definition (constraint solver threads 135-138).

The constraint solver threads then conduct the planning according the algorithms, heuristics, time constraints, and optimal scores specified in the planner definition. No database input/output (I/O) occurs at this time, as the actions are performed with in-memory data (planning data 130). Logic blocks (e.g., scoring logic blocks 140 and auxiliary logic blocks 145) specified in the planner definition for functions such as scoring the values assigned to planning variables may be called as necessary. Once the constraint solver has completed the planning, the final logic block specified in the planner definition (finalizer logic block 150) is called and passed the in-memory representation of the final values of each of the planning entities' planning variables that the constraint solver planned. Finalizer logic block 150 then packs the final values back into the database in a manner identified by the application developer. In some embodiments, finalizer logic block 150 performs post-processing on the final values before putting them into the database.

Logic blocks used in accordance with the present embodiment serve as an integral component of the planner. When an application developer uses the planner definitions application to define a planner definition to be executed, they implement the logic that makes the planner useful with logic blocks. Logic blocks for the planner are specialized in the sense that they are built on top of planner definitions rather than on top of tables. Thus, in the logic block editor, known in-memory data items are made explicitly available to the developer in the details pane of various actions. Some specific actions regarding values like scores and return values are also made available to developers.

Scorer logic blocks, such as scoring logic blocks 140, are responsible for calculating the hard, medium, and soft score of a planning variable's value as assigned by the constraint solver during planning. This score is then returned so that the planning engine and constraint solver can determine whether an optimal plan has been found, or if the search should continue. Auxiliary logic blocks, such as auxiliary logic blocks 145, are responsible for helping optimize the planning engine. Most auxiliary logic blocks are optional depending on a given scenario. The auxiliary logic blocks give an application developer optional access to low-level decisions that the planning engine makes during planning. The finalizer logic block, such as finalizer logic block 150, is responsible for performing any specified post-processing on the final plan and then ultimately packing the data back into the database as specified.

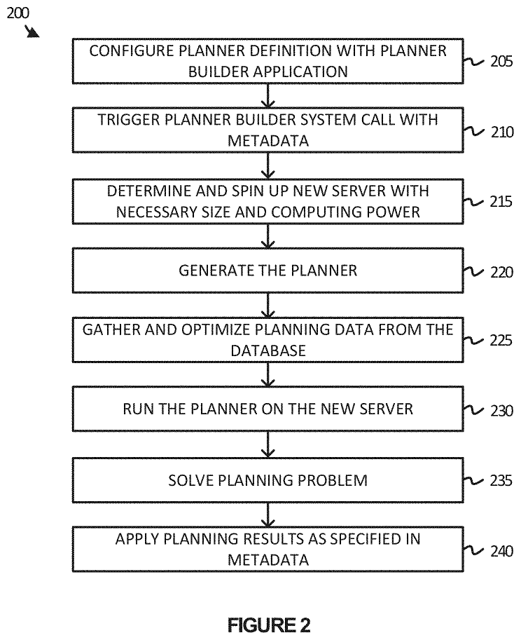

FIG. 2 illustrates process 200 for constraint planning in accordance with some embodiments of the present technology. In step 205, an application developer uses a constraint planner builder application to configure a planner definition. In step 210, the constraint planner builder application triggers a planner builder system call with metadata. According to the passed metadata, the planner builder system call determines and spins up a new server with the necessary size and power in step 215 and then generates the planner in step 220. Once the planner is generated, the server gathers and optimizes planning data from the database in step 225.

Once this prep work is complete, the planner is run on the new server in step 230. The constraint solver threads are responsible for then simultaneously solving the planning problem in step 235. The planning results are applied in step 240 according to the specifications in the metadata from a developer. The steps discussed in reference to process 200 may vary significantly depending on the implementation and may still be in accordance with the present disclosure. In some examples, process 200 is performed by a system architecture similar to planning environment 100. In other examples, process 200 or a similar process may be performed by an alternative planner architecture capable of performing the necessary steps for constraint-based planning in accordance with the present technology.

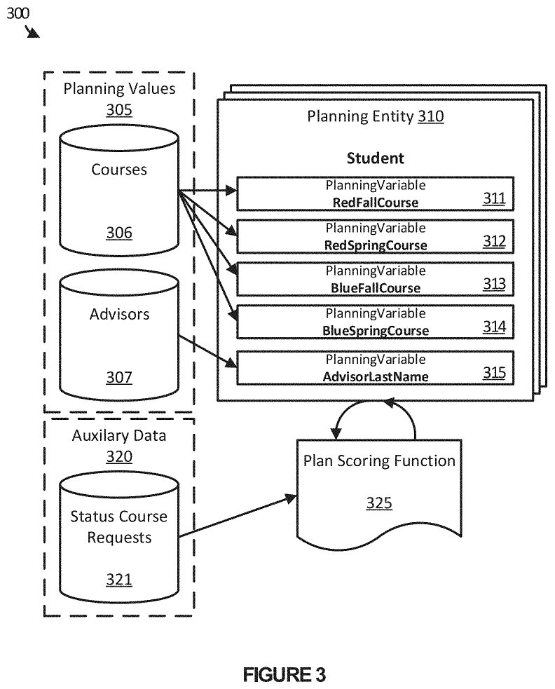

FIG. 3 shows data example 300 comprising a visual data example in accordance with some embodiments of the present technology. Data example 300 includes planning values 305, planning entity 310, auxiliary data 320, and plan scoring function 325. Planning values 305 include courses 306 and advisors 307. Planning entity 310 represents a student and includes the planning variables 311-314 which are, respectively, RedFallCourse (planning variable 311), RedSpringCourse (planning variable 312), BlueFallCourse (planning variable 313), and BlueSpringCourse (planning variable 314). As shown in FIG. 3, data from courses 306 may be used to fill planning variables 311-314. Data from advisors 307 may be used to fill planning variable 315, AdvisorLastName. Auxiliary Data 320 includes status course requests 321 which may be fed to plan scoring function 325 during scoring.

Most data used by the planning engine is stored in context properties and is global to the entire planning engine. The planning engine may retrieve, filter, sort, and then pack specified data into the context properties. This data may include planning entities (e.g., planning entity 310), planning variable values (e.g., planning values 305), auxiliary data (e.g., auxiliary data 320), and score enumerations (e.g., plan scoring function 325)—all sourced from existing tables in some examples. The data may also include optimized lookup data. Logic block-specific data, which is thread-specific and dynamic, may include logic block parameters (e.g., which planning variables a particular logic bock is supposed to be scoring) and logic block return data (i.e., scores and return values). Logic block-specific data may be passed to logic blocks via a data document.

In an example, data such as the type of data shown in FIG. 3, is used in accordance with the planning architecture and methods discussed herein to schedule an entire class of 250 students in under an hour while meeting all course requirements and all but seven course requests. The constraint planner of the present example is provided the school's student and course data, which includes 1,107 students, 1,124 offered courses, and 11,706 course requests, via a planner builder application. From the provided data, the constraint planner may assess all potential schedules (i.e., around 60,000-120,000+ schedules per second, depending on computing power and scenario) with standard computing resources. The system of the present example respects numerous constraints based on the planner definition including the following: never schedule a student for a course twice, never double-schedule a student's time, prioritize students in higher grade levels, attempt to fulfill student course requests, prioritize students with higher grade point averages, and never over-schedule a class. In the present example, all course requests may not and should not necessarily be met because other requirements take priority over the course requests.

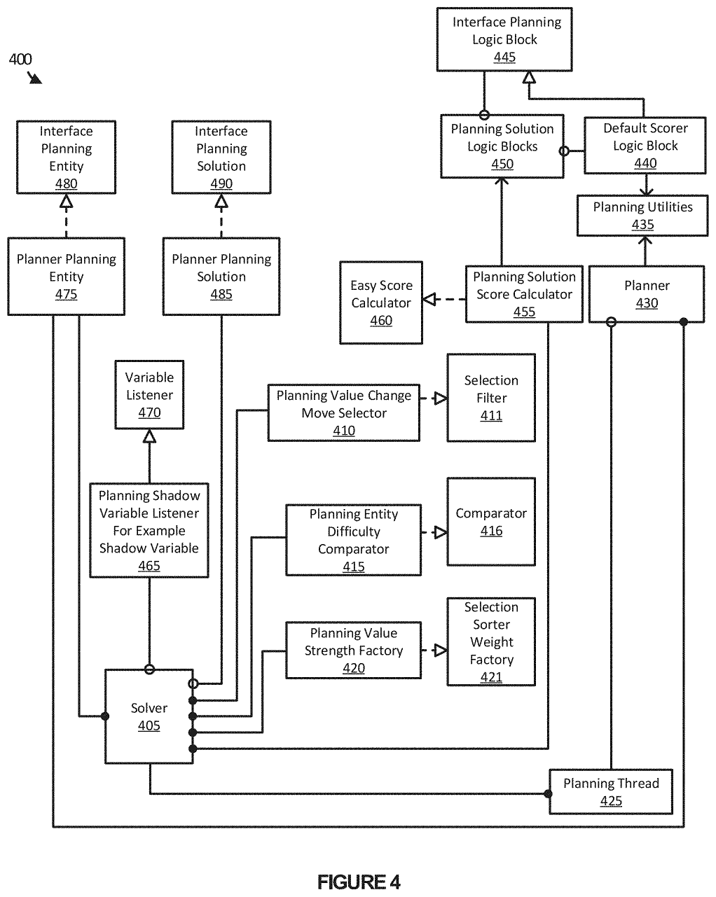

FIG. 4 shows a constraint planner class diagram that includes objects and relationships between objects on the server side of the system in accordance with some embodiments of the present technology. A constraint planner object is an immutable object that functions as an in-memory table referenced by the planner definition. Constraint planner objects exist as map-like structures that are stored in context properties of the context that gets passed to a given logic block at call-time. After the planning engine initially constructs an object (i.e., by pulling data from the database and putting it into the object), a constraint planner object is immutable for the remainder of the planner definition's execution. The purpose is to hold records from explicitly defined (i.e., defined in the planner definition) data sources, optimized lookups, auxiliary data, and entities.

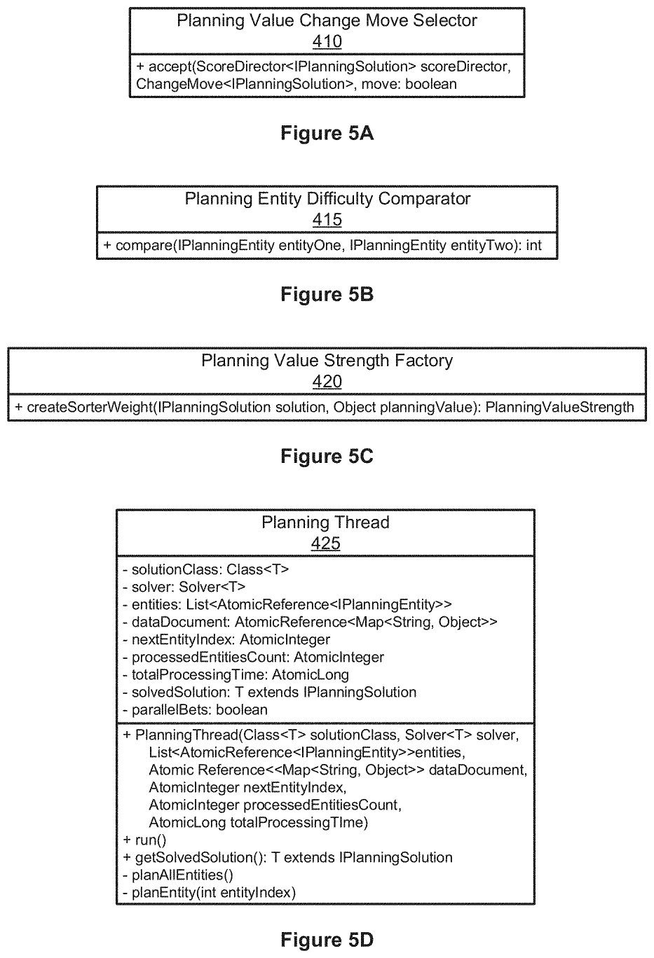

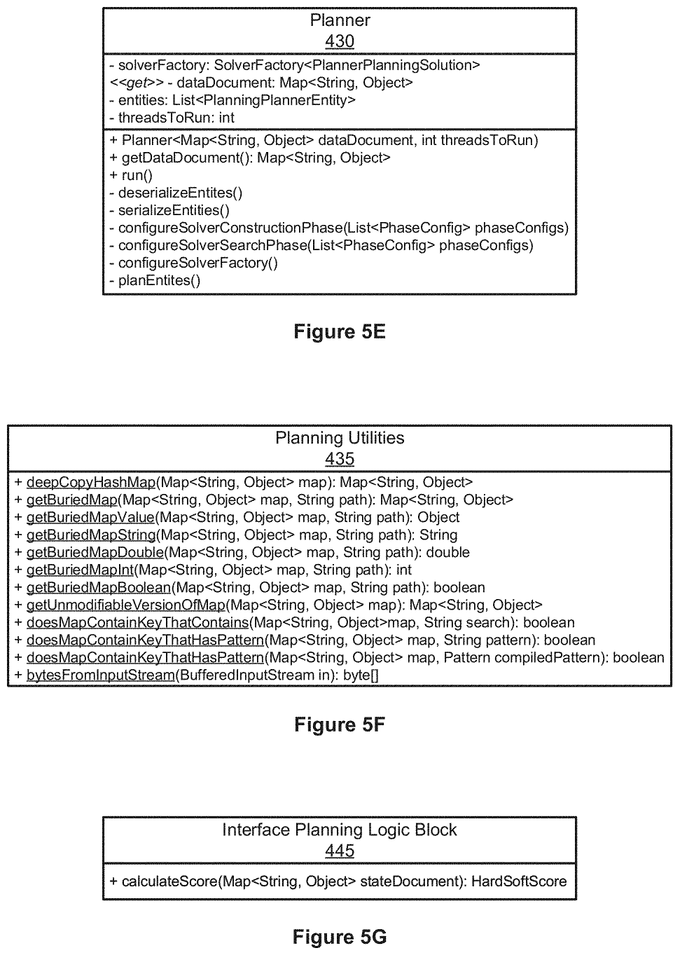

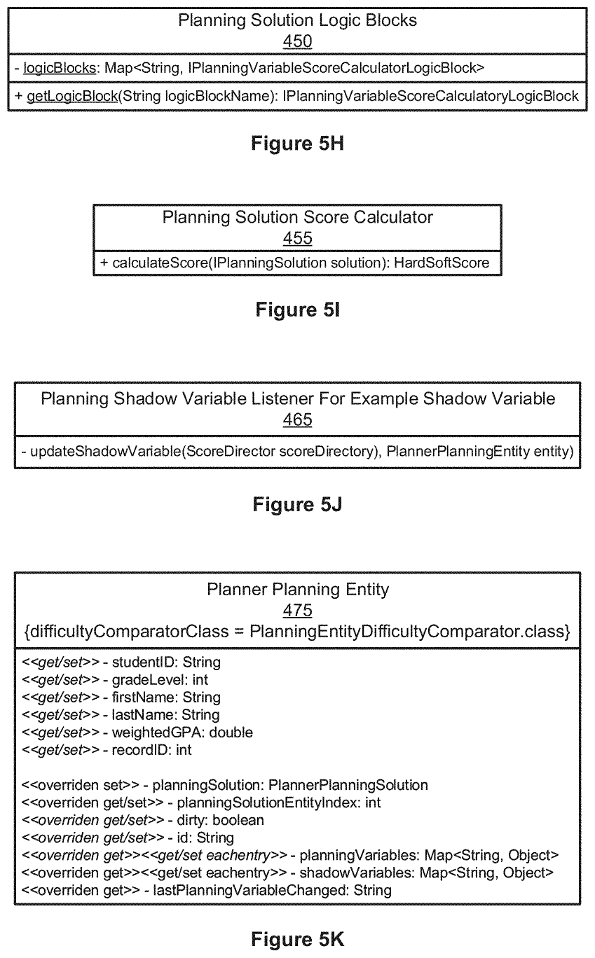

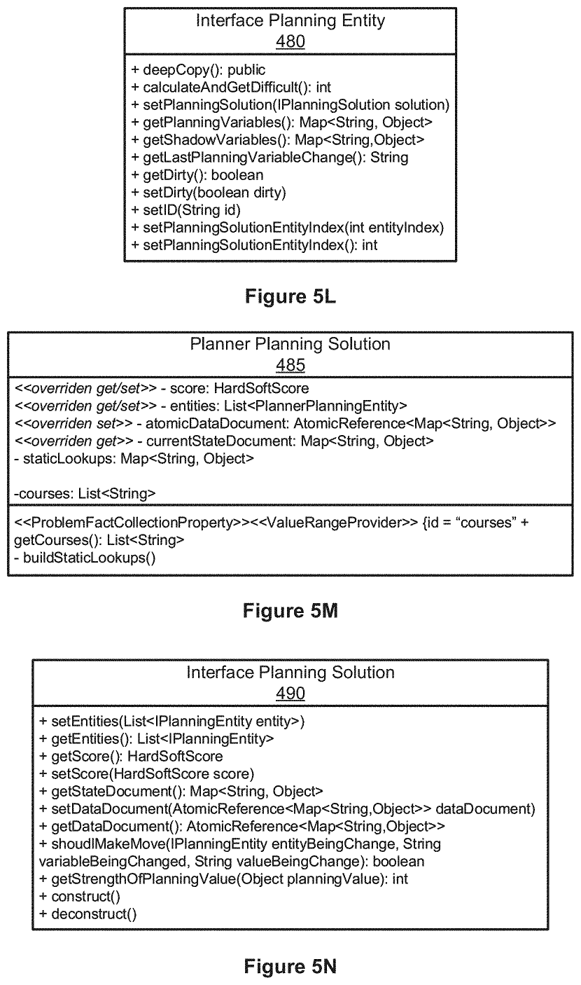

Class diagram 400 includes: solver object 405, planning value change move selector object 410, selection filter object 411, planning difficulty comparator object 415, comparator object 416, planning value strength factory object 420, selection sorter weight factory object 421, planning thread object 425, planner object 430, planning utilities object 435, default scorer logic block object 440, interface planning logic block object 445, planning solution logic blocks object 450, planning solution score calculator object 455, easy score calculator object 460, planning shadow variable listener for example shadow variable object 465, variable listener object 470, planner planning entity object 475, interface planning entity object 480, planner planning solution object 485, and interface planning solution object 490. Detailed representations of the objects of class diagram 400 are shown in more detail in FIGS. 5A-5N.

Planning shadow variable listener for example shadow variable object 465, planner planning entity object 475, and planner planning solution object 485 of the present example may be dynamically generated according to the user's configuration for the planner and are shown as representing objects in the student schedule planning problem, as previously discussed, but may be generated to represent objects of any planning problem. Planner object 430 is also dynamically generated and acts as a starting point for the entire planning engine. Planner planning entity object 475, shown in more detail in FIG. 5K, comprises getters and setters for each planning variable, each of which is annotated as a planning variable and given the ID of a value range provider in accordance with the constraint solver. Thus, in the student schedule planning problem where each planning variable represents a course that the student has been assigned, each entry expands to have its own getter and setter which are stereotyped as “<<PlanningVariable>> {valueRangeProviderRefs=‘courses’}.”

As previously mentioned, FIGS. 5A-5N show detailed examples of objects of class diagram 400. FIG. 5A shows planning value change move selector object 410. FIG. 5B shows planning entity difficulty comparator object 415. FIG. 5C shows planning value strength factory object 420. FIG. 5D shows planning thread object 425. FIG. 5E shows planner object 430. FIG. 5F shows planning utilities object 435. FIG. 5G shows interface planning logic block object 445. FIG. 5H shows planning solution logic blocks object 450. FIG. 5I shows planning solution score calculator object 455. FIG. 5J shows planning shadow variable listener for example shadow variable object 465. FIG. 5K shows planner planning entity object 475. FIG. 5L shows interface planning entity object 480. FIG. 5M shows planner planning solution object 485. FIG. 5N shows interface planning solution object 490.

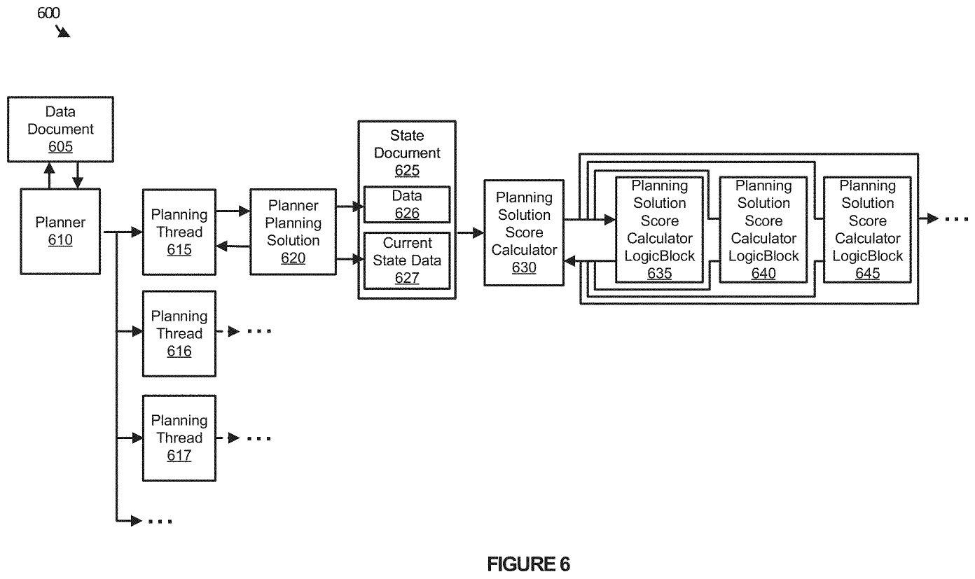

FIG. 6 illustrates constraint planner data flow 600 in accordance with some embodiments of the present technology. Constraint planner data flow 600 includes data document 605, planner 610, planning thread 615, planning thread 616, planning thread 617, planner planning solution 620, state document 625 including data 626 and current state data 627, planning solution score calculator 630, planning solution score calculator logic block 635, planning solution score calculator logic block 640, planning solution score calculator logic block 645, and the relational data flow between them. Prior to planning, planner 610 deserializes necessary components of data document 605 into objects for the constraint solver to use.

The planner provides data into each of planning threads 615-617 which then each provide outputs to planner planning solution 620. Original document data is provided to data 626 of state document 625 by planner planning solution 620 and new, dynamically generated data about the current state of the solution is provided to current state data 627 of state document 625 by planner planning solution 620. Data from state document 625 is then used by planning solution score calculator to calculate scores of plans using planning solution score calculator logic blocks 635-645. Planning solution score calculator 630 outputs one sequential scoring logic block call per planning variable. Scoring logic blocks can change data in current state data 627 to share with subsequent calls of other scoring logic blocks.

After a solution is solved, it is given the opportunity to deconstruct itself. Usually, this means that it has a chance to atomically serialize anything it needs to back into data document 605 for other solutions, including other planning threads, to make use of. For example, the number of students in a given course may need to be updated after a student's schedule is planned. After planning, planner 610 serializes results (i.e., entities with their planned planning variable values) back into data document 605.

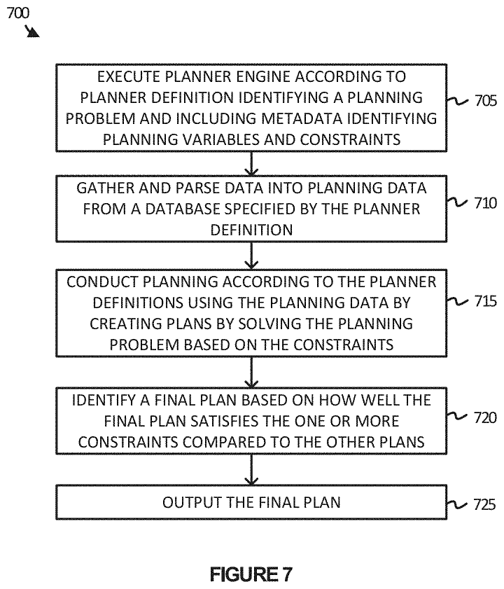

FIG. 7 is a flow chart illustrating a series of steps in process 700 performed by the planner engine in accordance with some embodiments of the present technology. In step 705, the planner engine is executed according to a planner definition, wherein the planner definition identifies a planning problem and includes metadata identifying planning variables and constraints. Executing the planner engine comprises initiating the planner engine in response to receiving a planner definition to run. The planner definition, in some examples, is created in a planner builder application. In step 710, the planner engine gathers data from a database specified by the planner definition and parses the data into planning data.

In step 715, the planner engine conducts planning according to the planner definitions using the planning data. In order to conduct planning, the planner engine creates plans by solving the planning problem based on the constraints. In some examples, step 715 is performed by one or more constraint solving modules of the planner engine, which may also utilize logic blocks to solve the planning problem in some implementations. In step 720, the planner engine identifies a final plan based on how well the final plan satisfies the one or more constraints compared to the other plans and then outputs the final plan in step 725. The final plan, in some examples, is the most optimized plan according to the requirements of the planner definition.

A constraint planner builder application in accordance with the present disclosure allows an application developer to specify numerous logic blocks that are used by the planning engine once the planner definition being created is executed. The logic blocks that are specified are built on top of a planner definition (specifically, the one they will be plugged in to) so that the logic block builder user interface (UI) can expose specific data fields and the like that have been pointed to in the definition. The logic blocks are also capable of in-memory data I/O (e.g., in contexts and in driver documents) and, with the exception of one case, the logic blocks do not allow any database I/O for performance reasons.

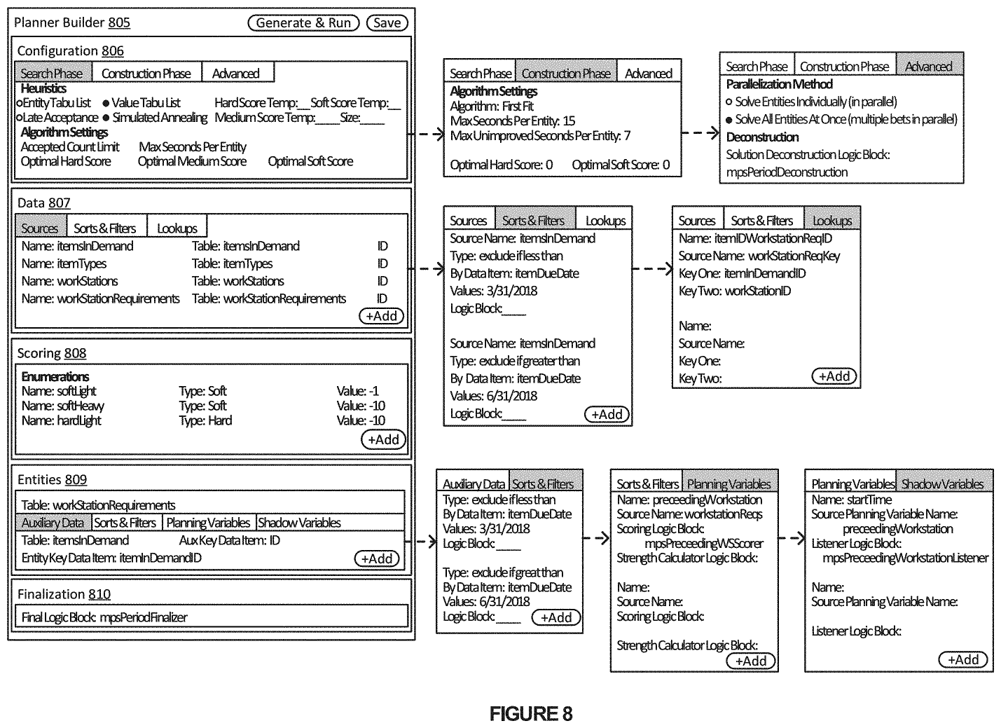

FIG. 8 shows a mockup of an exemplary user interface of a constraint planner builder application in accordance with the present technology. FIG. 8 shows planner builder 805 which includes configuration pane 806, data pane 807, scoring pane 808, entities pane 809, and finalization pane 810. Configuration pane 806 comprises settings windows including search phase, construction phase, and advanced, wherein the search phase window is shown within configuration pane 806, while the construction phase window and advanced settings window are shown to the right configuration pane, respectively. Data pane 807 includes sources window, sorts and filters window, and lookups window. Sources window is shown within data pane 807 and sorts and filters window and lookups window are shown to the right of data pane 807, respectively. Entities pane 809 includes an auxiliary data window, sorts and filters window, planning variables window, and shadow variables window. The auxiliary data window is shown in entities pane 809, while sorts and filters window, planning variables window, and shadow variables window are shown to the right of entities pane 809.

In addition to the functionalities and similar functionalities to those shown in FIG. 8, inputs and settings for resource requirements, personnel requirements, and the like may be included in planner builder 805. Furthermore, workstation time requirements may be driven by factors such as minimum time required per workstation to maintain a certain level of quality.

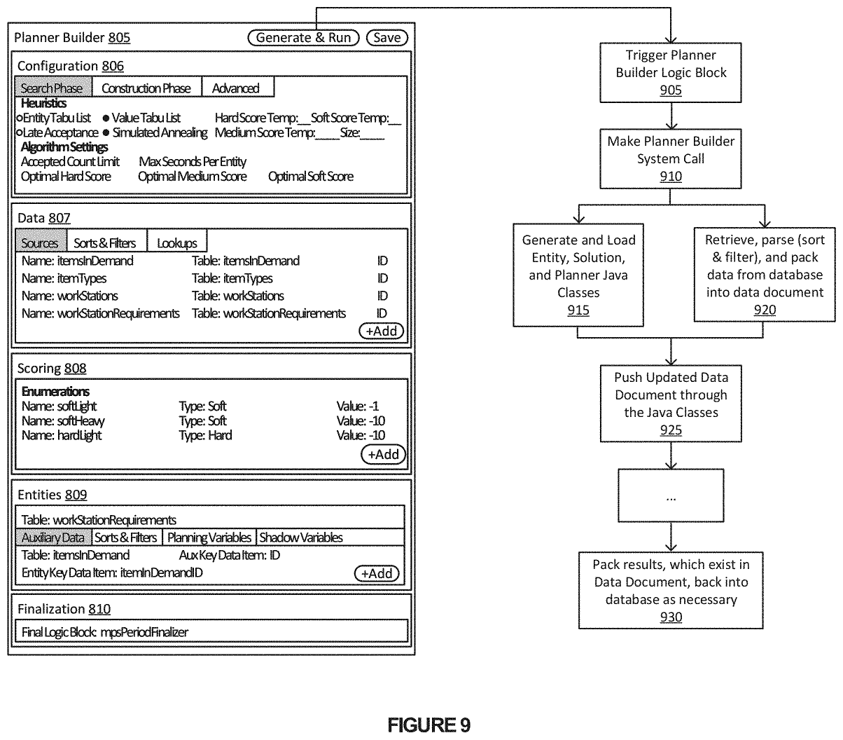

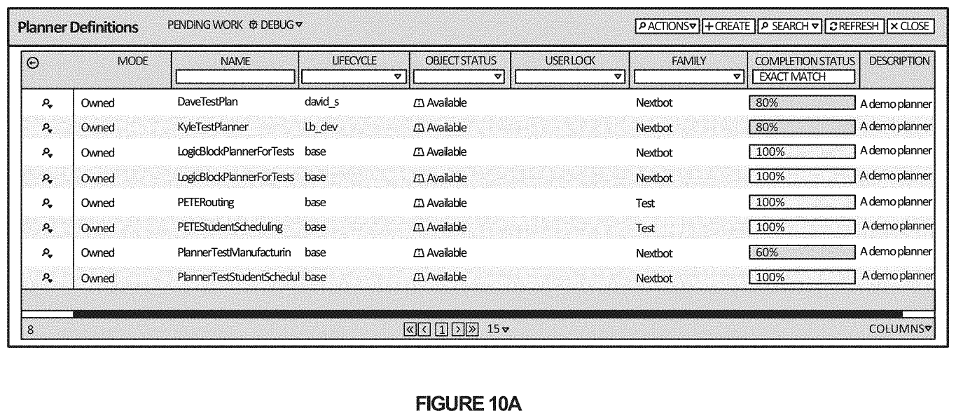

The panes and windows shown in the example user interface of FIG. 8 serve to illustrate exemplary input data for building a constraint planner in accordance with the present technology. By inputting data, settings, and the like within planner builder 805, a planner builder can be defined prior to being generated and run. FIG. 9 shows a process that initiates in response selecting “generate and run” in planner builder 805. In step 905, the planner builder application triggers a planner builder logic block and makes a planner builder system call in step 910. After making the planner builder system call, the planner builder performs one or both of generating and loading entity, solution, and planner Java classes in step 915 and retrieving, parsing (sorts and filters), and packing data from the database into the data document in step 920. The builder then pushes updated data through the generated Java classes in step 925, which is followed by a running of the planning engine to solve the planning problem before packing results, which exist in the data document, back into the database as necessary in step 930.

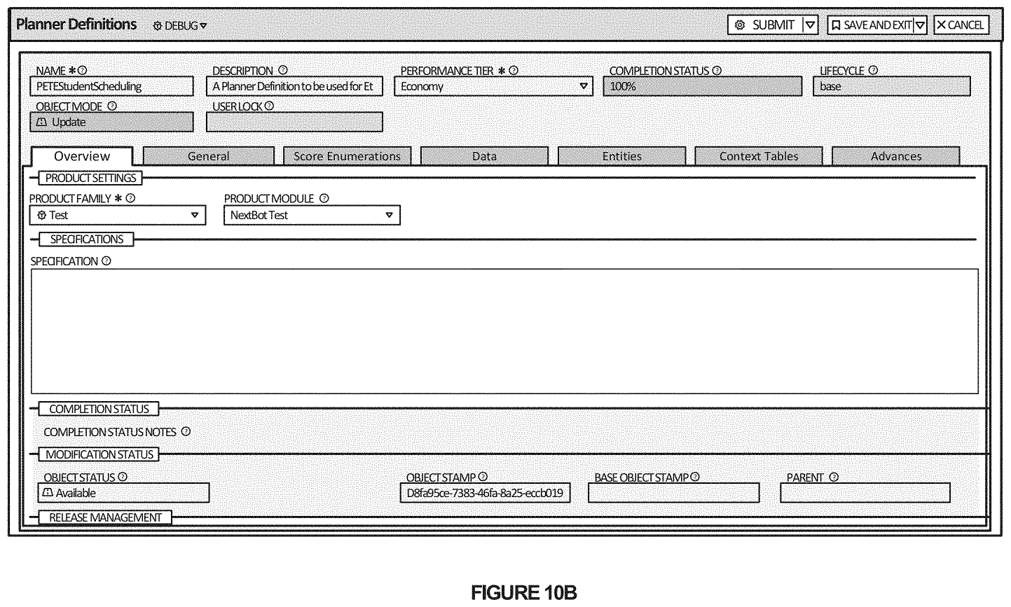

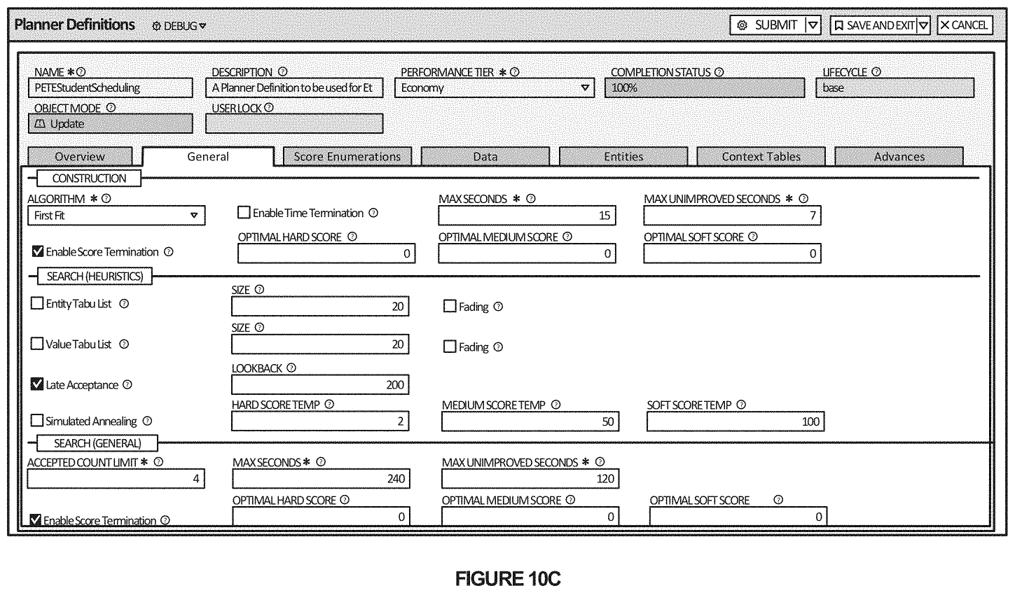

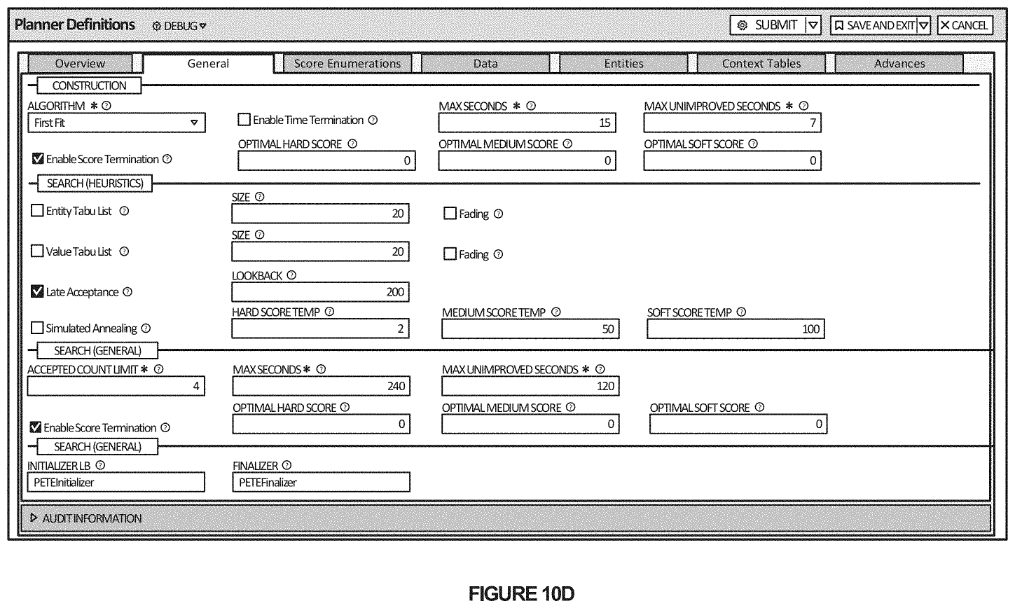

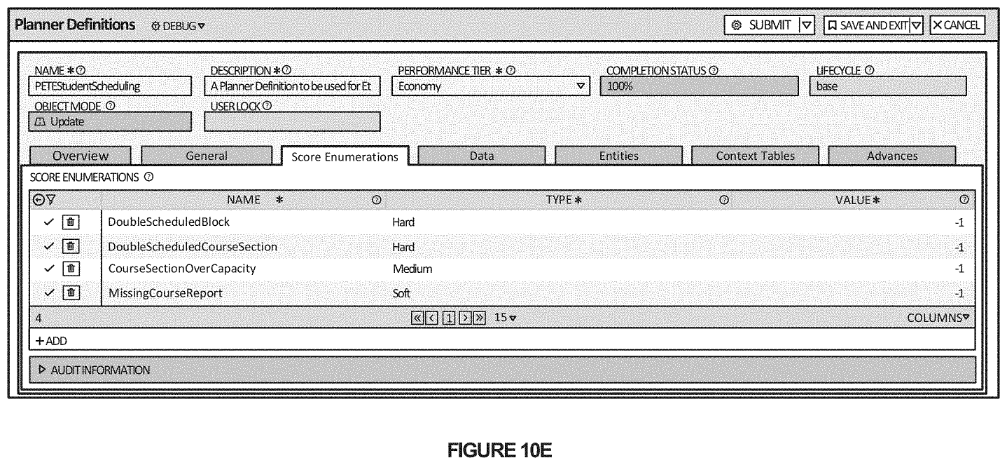

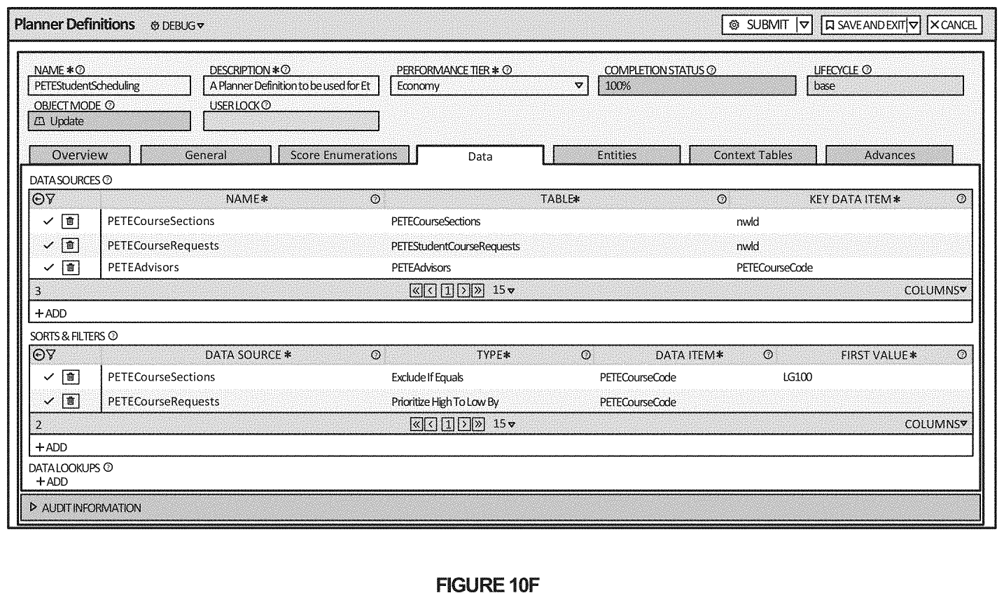

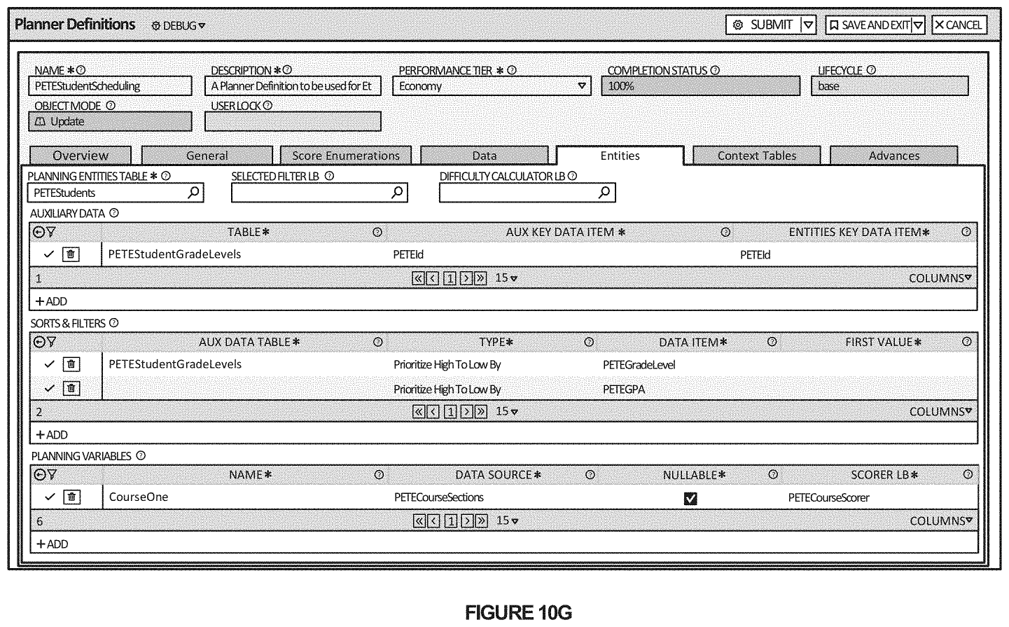

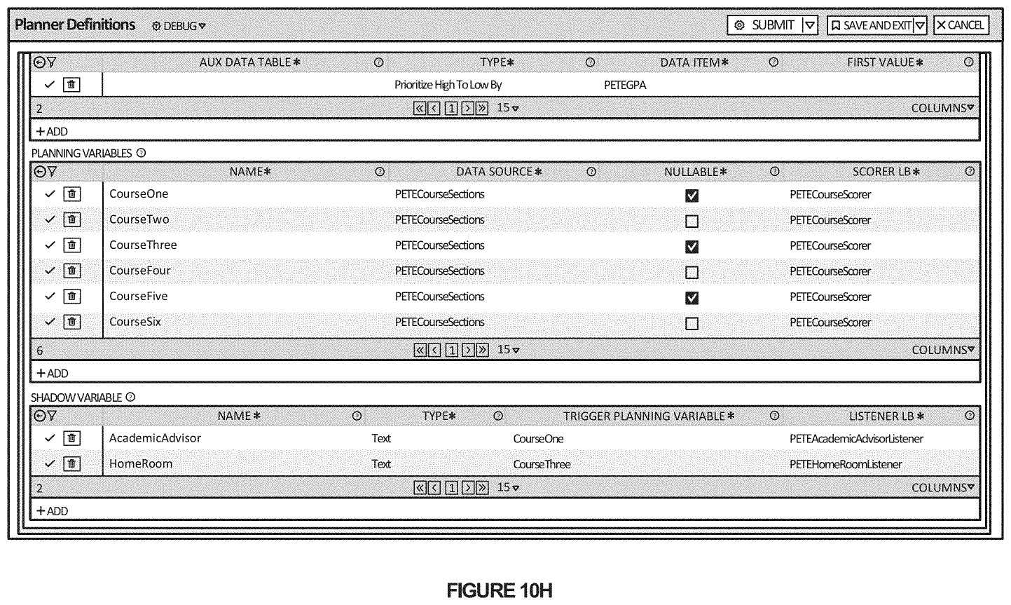

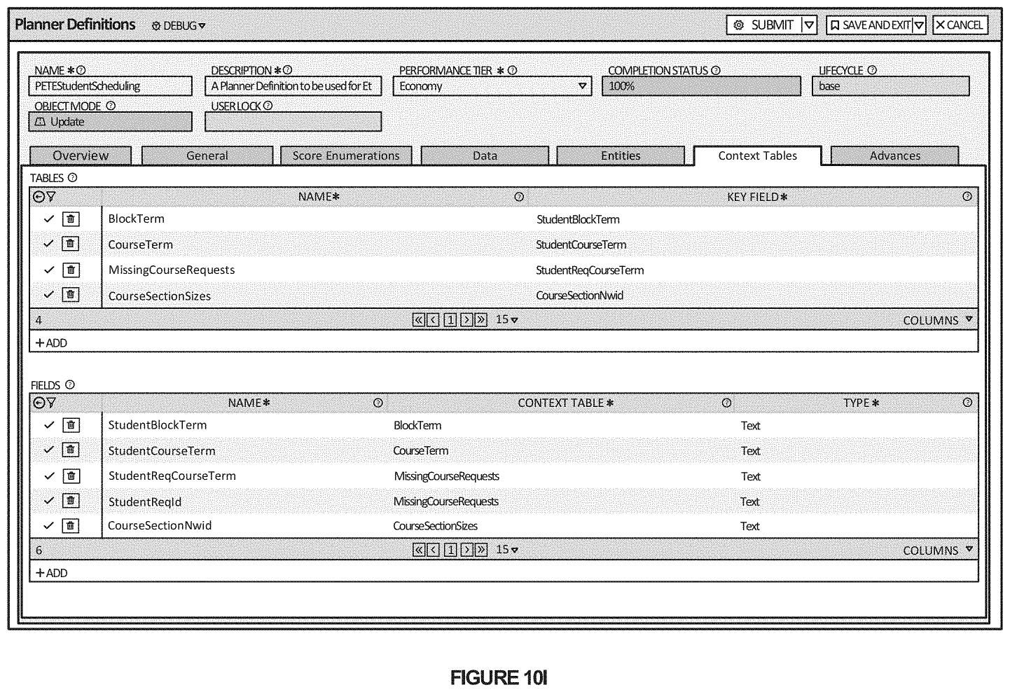

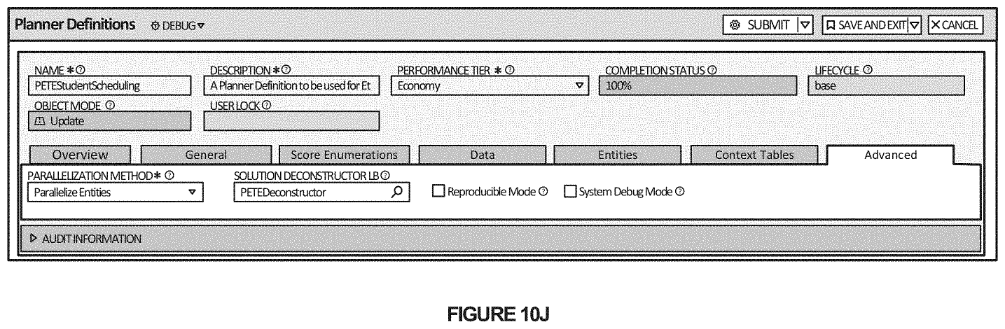

FIGS. 10A-10J show example user interface designs of a constraint planner builder application in accordance with some embodiments of the present technology. FIG. 10A shows a list view of the planner builder application. The list view shows various planners that have been built or are in the progress of being built. FIG. 10B shows planner definition information that may appear to a person building a planner in some embodiments and more specifically shows details in the overview tab of a planner definition. Data fields include name, description, performance tier, completion status, lifecycle, object mode, and additional data fields shown for defining a planner. The performance tier field allows a developer building a planner to specify how fast and how well they want the planner to find an optimal solution to their planning problem. Higher tiers directly correlate to more CPUs and more RAM for the planner to use during planning.

FIG. 10C shows details in a general tab of a planner definition. The settings in the general tab include the functionality that a person building a planner may use to identify to the planner how it should find an optimal solution to the planning problem it is intended to solve. Most of the options and data entry points of the present example allow for various algorithms that are commonly used to solve planning problems to be turned on or off, as well as configured for fine-tuning. FIG. 10D shows additional details in the general tab of a planner definition. Two logic blocks can be specified in the fields “INITIALIZER LB” and “FINALIZER LB.” These fields allow for logic blocks, if desired, to be plugged into the planner such that they can perform pre-planning and post-planning data cleaning and processing. If an alternative mechanism for implementing business logic (e.g., actual programming language code) exists, it may be allowed that the alternative mechanism can be plugged into the logic block fields of a planner.

FIG. 10E shows details in a score enumerations tab of a planner definition. Score enumerations allow a person building the planner to define user-friendly names for the consequences of breaking various constraints. These names may then be referenced in the logic blocks that are plugged into the planner to enforce the constraints. Score enumerations and scoring are an important component of planner building because the planner in accordance with the present example is incentive driven—when run, it attempts to find a solution with the most optimal score, as defined in the general tab. If the planner identifies a bad score when it takes a certain action on a solution it is working on, it will stop taking that action. Thus, the planner becomes more trained the further along it gets in planning a solution. FIG. 10F shows details in a data tab of a planner definition. In order for a planner to plan an optimal solution, it must have access to the business data relevant to the planning problem. The data tab allows that data to be plugged in and optionally cleaned. No data lookups are shown in the present example. However, data lookups provide a mechanism for translating the business data that has been plugged in into a form that is more convenient for scoring potential solutions. Translating the business data in this way helps make the process of retrofitting a planner onto a legacy set of business data that may not be in an optimal form, fairly trivial.

FIG. 10G shows details in an entities tab of a planner definition. Planning entities are the individual components that the planner plans. Similar to the data tab, the entities tab is where a business data table holding records for each student to plan a schedule for is referenced. The final set of planned schedules for all students in the table is considered the solution once the planner is run. The entities tab includes, in part, an auxiliary data section and a sorts and filters section. Auxiliary data of the entities tab allows the joining of the planning entities table to extra data in order to augment it. For example, if student grade point averages are stored in a separate table of business data from the table that holds their current grade level, the table may be augmented to include the extra data. Auxiliary data allows for trivial retrofitting onto a legacy set of business data. The sorts and filters section of the entities tab, similar to the data tab, provides a mechanism to perform some data cleaning and prioritizing of the planning entities to be planned.

FIG. 10H shows additional sections of the entities tab including the planning variables section and the shadow variables section. Planning variables are the actual fields that a planner will put values into, from the specified data source, in an attempt to find an optimal solution. Each planning entity has each planning variable to be planned. For example, if 6 students each require 6 courses in their schedule, there are 36 slots to be filled with the plan. Shadow variables are not directly planned by a planner. Instead they are updated by a logic block whenever a specified trigger planning variable is changed by a planner. For example, if each student should be assigned the same home room as their third course class, that may be specified as a shadow variable.

FIG. 10I shows details in a context tables tab of a planner definition. Context tables provide a way of defining in-memory tables that can be used by logic blocks that have been plugged into a planner during runtime. Context tables can be used to score data and to communicate between the various other threads that are also trying to find optimal solutions to the planning problem. Context tables exist as atomic map-like structures referenced by context properties. Context tables and their fields are predefined in the planner definition, but they are empty records at the beginning of the execution of the planner definition. Logic blocks called by the planning engine during execution can add, remove, update, and fetch records in a similar fashion to doing the same to a temporary table.

FIG. 10J shows detail in an advanced tab of a planner definition. Different parallelization methods provide a mechanism for building planners that can solve different types of planning problems. Parallelizing entities may plan each planning entity individually and then combine each individual planning solution. If planning entities do not need to be planned in a given order, parallelizing entities can be an extremely efficient process. Parallelizing bets plans all entities together at once many times in different ways and then picks the most optimal planning solution that was found. Parallelizing bets may be necessary for solving problems where each planning entity depends on every other planning entity such as package routing problems. Additional options in the advanced tab may allow for easy post-planning cleanup and debugging of planners built.

More details will be described here regarding logic blocks for a constraint-based planning system in accordance with some embodiments of the present technology. For some implementations of logic blocks in accordance with constrained planning methods used herein, the server side and the UI side of preexisting logic blocks are enhanced. From the UI side (i.e., planner definition data), logic blocks that will be used by the planner may be built on-top of specific planner definitions instead of tables. As such, the logic block builder requires knowledge of the planner definitions. Inside the logic blocks application, an application developer is able to create new scoring, auxiliary, and finalizer logic blocks for a planner. To do this, a developer may specify a specific record in a planner definitions table rather than an actual table on top of which the logic blocks are to be built. Information from this record can then be used to explicitly expose specific fields in the logic block planner application.

On the server-side of the system exists constraint planner object data. Constraint planner objects are immutable, in-memory representations of data referenced by the planner definition. This data includes data sources, data lookups, entities (joined with auxiliary data), and additional data discussed below. Objects can be stored in the following context properties of the context table and passed to a given logic block at call time, in some examples. The context properties in one example include: plannerDataSources—holds in-memory representations of the records of data sources tables referenced and data lookups defined by the planner definition; plannerDataSourcesSorted—similar to plannerDataSources, but data sources are represented by sorted lists instead of keyed maps; plannerDataSourceKeysSorted—similar to plannerDataSourcesSorted, but only the keys of records are held rather than the entire record; plannerEntities—holds an in-memory representation of the records of the entities table referenced by the planner definition (joined with each record representation is the associated data from any auxiliary data tables referenced by the planner definition (note that all entries in this constraint planner object have fully-qualified keys (i.e., TableName.DataItemName) due to the optional joins that can be defined)); plannerEntitiesSorted—holds an in-memory representation similar to that of plannerEntities, but as a sorted list rather than a keyed map; plannerEntitiesPlanningVarsDataSources—holds a map of planning variable names to the names of the data source that is supposed to provide possible values for each variable; plannerEntitiesPlanningVarsScorerLBs—holds a map of planning variable names to scorer logic block NwIds; plannerEntitiesPlanningVarsStrengthCalculatorLBs—holds a map of (optional) entries keyed by planning variable name and valued with the NwIds of the logic block specified to calculate the strength of the planning variable's value; plannerEntitiesShadowVarsListenerLBs holds a map that keys shadow variable names to the NwIds of the logic blocks that are to calculate their value when triggered; plannerEntitiesShadowVarsTriggerPlanningVars—holds a map that keys shadow variable names to the names of the planning variables that are supposed to trigger a re-calculation of their value; plannerEntitiesShadowVarsTypes—holds a map that keys shadow variable names to their data type; plannerScoreEnumerations—holds a map that keys the names of score enumerations defined in the planner definition to their defined value; plannerScoreEnumerationTypes—holds a map that keys the names of score enumerations defined in the planner definition to their type (i.e., “hard”, “medium”, or “soft”); plannerLBs—holds a map of various solo Logic Blocks referenced by the planner definition; plannerFinalizerLB—holds the NwId of the finalizer logic block specified in the planner definition; plannerSolutionDeconstructorLB—(optional) holds the NwId of the logic block specified in the planner definition to perform deconstruction when an optimal planning solution has been found; plannerEntityDifficultyCalculatorLogicBlock—(optional) holds the NwId of the logic block responsible for calculating the difficulty of a provided planning entity; and planner ValueSelectionFilterLogicBlock—(optional) holds the NwId of the logic block responsible for determining whether or not a particular planning entity's particular planning variable should be changed to have a proposed value.

Context tables, comprising context table data (server-side), are similar to constraint planner objects in that they exist in the context properties of the context that gets passed to a given logic block at call time. The difference, however, is that context tables are atomically mutable (i.e., they exist as special, atomic (thread-safe), map-like objects) due to the fact that they can be used in a somewhat similar way to temporary tables. The structure holding the records of a context table as well as the structure representing actual records within a context table itself may be built using a ConcurrentHashMap class provided by Java due to the fact that the records must be able to be added, removed, and updated in a thread-safe manner. The context property that functions as the entry-point for accessing all context tables defined by a planner definition is: plannerContextTables—an immutable map of special, atomic maps that represent context tables defined by the planner definition. Another context property exists that holds the name of the key field of each defined context table. When records are inserted into a context table, they should be keyed by their value associated with this field. Additional context properties include: plannerContextTableKeyFields—an immutable map of the names of defined key fields for all defined context tables; plannerContextTableFieldTypes—an immutable map of the names of defined context table fields and their associated defined type; and plannerContextTableFields—an immutable map key by the names of defined context tables and valued with immutable lists of the names of the context table fields defined for the context table.

The planner logic block types described herein make use of a new paradigm referred to as parameter data (server-side). Each parameter data is simply data that is passed to the logic block at call time via a special object inside of the drive document that gets handed to it. This special object may be keyed as plannerLBParameterData and contains child objects specific to the logic block planner sub-type being called. The possible parameters are exposed to the planner logic block types inside of the logic block builder. However, only certain parameters comprise a value (i.e., are not null and not empty) depending on the logic block's type and place that it has been plugged into in a planner definition. The following parameters may be defined and exposed in the logic block builder, in the present example: planningVariableValues—a document comprising the current (at logic block call-time) planning variable values for planning entities—the structure looks like “Document<(String) Planning Entity Id, Document<(String) Planning Variable Name, (Object) Planning Variable Value>>”—the specific values for this structure are accessed inside of a fetch entity records loop; shadowVariableValues—a document comprising the current (at logic block call-time) shadow variable values for planning entities—the structure looks like “Document<(String) Planning Entity Id, Document<(String) Shadow Variable Name (Object) Shadow Variable Value>>” and the specific values for this structure can be accessed inside of a fetch entity records loop; planningVariableName—a string that holds the name of the planning variable upon which the logic block should act (the actual action that should be performed depends on the type of logic block and where it is plugged into the planner); planning Variable Value—an object that holds the value of the planning variable upon which the logic block should act (the actual action that should be performed depends on the type of logic block and where it is plugged into the planner); shadowVariableName—a string that holds the name of the shadow variable upon which the logic block should act (the actual action that should be performed depends on the type of logic Block and where it is plugged into the planner); planningEntityId—a string holding the ID of the planning entity upon which the logic block should act (the actual action that should be performed depends on the type of logic block and where it is plugged into the planner); and logicBlockRole—a string referring to the role of the logic block at call-time according to where it was plugged into the planner.

Specific uses for the aforementioned variables depending on the planner logic block type are discussed herein. Scoring logic blocks may use the following parameters in an example: planningVariableValues—holds the current planning variable values for the planning entity whose planning variable is being scored (no other planning entities planning variables are included); shadowVariableValues—holds the current shadow variable values for the planning entity whose planning variable is being scored (no other planning entities shadow variables are included); planningVariableName—holds the name of the planning variable of the specified planning entity to score; planningEntityId—holds the ID of the planning entity whose planning variable is to be scored; and logicBlockRole—“planner scorer (first)” on the first planning variable for a planning entity, and “planner Scorer (last).” All other parameter data in scoring logic blocks is null.

Finalizer logic blocks may use the following parameters in an example: planningVariableValues—holds the final planning variable values for all of the planning entities that were planned; shadowVariableValues—holds the final shadow variable values for all of the planning entities that were planned; and logicBlockRole—is the planner finalizer. All other parameter data in finalizer logic blocks is null in the present example.

Auxiliary logic blocks can use different parameter data depending on where they are plugged into a planner definition. When plugged in as a selection filter for the planning entities, auxiliary logic blocks may use the following in an example: planningVariableValues—holds the current planning variable values for the planning entity whose planning variable's value is being filtered (no other planning entities planning variables are included); shadowVariableValues—holds the current shadow variable values for the planning entity whose planning variable's value is being filtered (no other planning entities shadow variables are included); planningEntityId—the ID of the planning entity whose planning variable's value is currently being filtered; planningVariableName—the name of the planning variable whose value is being filtered; planningVariableValue—the value that has been proposed for the specified planning variable to be changed to; and logicBlockRole—“planner auxiliary selection filter.”

When plugged in as a difficulty calculator for the planning entities, auxiliary logic blocks may use the following in an example: planningVariableValues—holds the current planning variable values for the planning entity whose planning difficulty is being calculated (no other planning entities planning variables are included); shadowVariableValues—holds the current shadow variable values for the planning entity whose planning difficulty is being calculated (no other planning entities shadow variables are included); planningEntityId—the ID of the planning entity who the logic block is calculating the difficulty of; and logicBlockRole—“planner auxiliary difficulty calculator.”

When plugged in as a shadow variable listener, auxiliary logic blocks may use the following in an example: planningVariableValues—holds the current planning variable values for the planning entity whose shadow variable's new value is being calculated (no other planning entities planning variables are included); shadowVariableValues—holds the current shadow variable values for the planning entity whose shadow variable's new value is being calculated (no other planning entities shadow variables are included); planningEntityId—the ID of the planning entity who's shadow value got triggered for a re-calculation; shadowVariableName—the name of the shadow variable that the logic block is calculating a new value for; and logicBlockRole—“planner auxiliary shadow variable listener.”

When plugged in as a solution deconstructor, auxiliary logic blocks may use the following in an example: planningVariableValues—holds the current planning variable values for all of the planning entities that are planned (note that when parallelizing planning entities, not all will be planned at any given time); shadowVariableValues—holds the current shadow variable values for all of the planning entities that are planned (note that when parallelizing planning entities, not all will be planned at any given time); and logicBlockRole—“planner auxiliary solution deconstructor.”

In the same way that parameter data comes into a logic block at its call time via the driver document, return data comes out of a logic block as immediate child objects to the root object. The following objects may be expected by the planning engine to come out of calls to constraint planner scoring logic blocks via the driver document in an example: plannerLBReturnHardScoreValue (integer)—the final value of the running hard score tally as modified by update score action; plannerLBReturnMediumScoreValue (integer)—the final value of the running medium score tally as modified by update score actions; and plannerLBReturnSoftScoreValue (integer)—the final value of the running soft score tally as modified by the update score actions.

The following objects may be expected by the planning engine to come out of calls to constraint planner auxiliary logic blocks via the driver document in an example: plannerLBReturnValueType (string)—data type of the return value (e.g., “true/false,” “text,” or “number”); and plannerLBReturnValue (object)—the actual return value of whatever type is specified by the plannerLBReturnValueType. Depending on where an auxiliary logic block has been plugged into a planner definition, it may be expected to return different data. When plugged in as a strength calculator for a planning variable, an auxiliary logic block may be expected to return a numerical value representing the strength of the planning variable value. When plugged in as a selection filter for the planning entities, an auxiliary logic block may be expected to return a Boolean value indicating whether or not the planning variable's value should be changed as specified. When plugged in as a difficulty calculator for the planning entities, an auxiliary logic block may be expected to return a numerical value representing the calculated difficulty of the planning entity. When plugged in as a shadow variable listener, an auxiliary logic block may be expected to return a value, usually a number or string, that functions as the shadow variable's new value. When plugged in as a solution deconstructor, the auxiliary logic block may be expected to return nothing. Constraint planner logic blocks are not expected to provide any return data in some embodiments.

The constraint planner therefore utilizes three new logic block types to be created and exposed to application developers in an embodiment of the present technology. Each of these new logic block types provide a slightly different action palette and have unique functional characteristics. As such, both the server-side and the UI-side of logic blocks are enhanced accordingly to provide and support these new logic block types. The first type, a scoring logic block, can be plugged in to a planner definition in the constraint planner builder application by an application developer to score the values of planning variables that are set by the planning engine during execution. These logic blocks are the primary place where an application developer may implement the necessary constraints for the planning problem that they are developing a solution for. For example, an application developer's implementation of a scoring logic block might calculate a negative score if the current planning variable values that the planning engine has come up with do not satisfy a student's course requests or requirements, or if they place a student in a course that is already full. In order to do this, it needs access to the current planning variable values, as well as have access to some other data such as the student's course requests, available courses and their current capacity, and the like. Specific requirements of the scoring logic block type include that a scoring logic block, in some implementations: must not allow any database I/O actions, must not allow any nested logic block call actions, must allow regular data-related actions, must allow new actions related to context tables, constraint planner objects, and parameter data, must allow new actions related to adjusting score values, must keep a running tally of the hard, medium, and soft scores as integers, and must write the total score tallies back to driver document integer objects as cpLBReturnHardScore, cpLBRturnMediumScore, and cpLBReturnSoftScore at the end of the logic block's execution.

The second type, an auxiliary logic block, can be plugged in to a planner definition by an application developer in order to customize specific aspects of the algorithms and heuristics that the planning engine uses to solve a planning problem in an embodiment of the present technology. As such, in many cases, an application developer's use of these logic blocks is completely optional—the planning engine can do generic calculations on its own in the areas where these logic blocks can be plugged in. Auxiliary logic blocks are, however, useful for optimizing very complex planning problems. For example, if an application developer wanted to give the planning engine a hint about the fact that advanced-placement (AP) courses are more likely to create an optimal schedule for a student than elective courses are, they could implement an auxiliary logic block to return a higher strength value when passed an AP course than any other course and then plug that value into the planner definition appropriately. Requirements of an auxiliary logic block, in the present implementation, may include the following: must not allow any database I/O actions, must not allow any nested logic block call actions, must allow regular data-related actions, must allow new actions related to context tables, constraint planner objects, and parameter data, must allow new actions related to adjusting the return value, must keep track of the return value, must allow the return value to be a Boolean (i.e., explicitly true or false) or any possible constant or variable that a logic block allows, and must write the return value back to the driver document as an object keyed by cpLBReturnValue at the end of the logic block's execution.

The third type of logic block, the finalizer, can be plugged in to a planner definition by an application developer in order to pack the planning variable values that the planning engine determined to be most optimal back into the database in an embodiment. An application developer may optionally choose to do some post-processing of these values before packing them back into the database. Specific requirements of a finalizer logic block, in some examples, include the following: must allow database I/O, must allow regular data-related actions, and must allow new actions related to context tables, constraint planner objects, and parameter data.

In order to provide the functionality that the planner gets from the aforementioned logic blocks, and to expose specific fields that are defined in a given planner definition that a planner logic block can be built on top of, new logic block actions may be made to support things like in-memory data manipulation and management, score, and return values. The first new logic block action is the update score action, in an embodiment of the present technology. The update score action is only allowed in scoring logic block sub types. The update score action allows for the explicit selection of score enumeration values that are in the planner definition that the logic block is being built on. These keep a running tally, are a single value, and are integers. Score enumeration values are defined in each individual planner definition. There can be multiple of each type, such as multiple soft enumeration values designated by their unique names, in some examples. The update score action may also allow for an explicit choice between adding, removing, or setting the chosen score value to the associated current score tally.

The second new logic block action of the present embodiment is the update return value action. The update return value action is only allowed in auxiliary logic block sub types and returns a single value. This action allows for the explicit selection of a value to set the return value to of true or false, or for the selection of a variable value, or the entering of a constant value for the return value. The type of return value returned in an update return value action is defined by the logic builder. Update return value actions return a value at run time and nulls are not allowed to be returned.

The third new logic block action of the present embodiment is the fetch constraint planner records action. This action allows for fetching constraint planner object records that exist in maps stored in context properties. These records are placed there by the planning engine based on the data sources specified in the planner definition being run. The fetch information indicates the key value of the records for the update action. The fetch constraint planner records action allows for the explicit selection of an iteration over known constraint planner objects that are specified in the planner definition (e.g., students, courses, course requests, etc.). Fetch operations result in a single document source name (DSN). The fetch constraint planner records action includes a fetch loop, multiple or single, wherein a use can specify a limit to do things like fetching a single record. The fetch loop utilizes filter functionality to know the key for a single record fetch and all other filters available.

The fourth new logic block action of the present embodiment is the clear context table logic block action which allows a user to clear all of the records that currently exist in a predefined context table. The clear context table action requires that context tables are in-memory tables that do not equate to a DSN. These actions allow for the clearing of a predefined context table.

The fifth new logic block action of the present embodiment is the insert context table records action, which allows a user to insert new records into a predefined context table. The insert context table records action creates a DSN along with inserting the row into a context table. Insert methods in accordance with this action are exposed to logic blocks via the context. The context methods mask the labor away from logic blocks required to insert into a context table.

The sixth new logic block action of the present embodiment is the update context table records logic block action, which allows a user to update existing records in a predefined context table. The update context table records action updates an existing DSN. Update methods are exposed to logic blocks via the context and the context methods mask all the labor away from logic blocks for updating a context table.

The seventh new logic block action of the present embodiment is the delete context table records logic block action, which allows a user to delete specific existing records from a predefined context table. A delete context table records action may delete a specific DSN. The eighth new logic block action of the present embodiment is the fetch context table records action, which allows for querying and iterating over records that exist a predefined context table. Constraint planner parameters are exposed like fields in the appropriate actions. These parameters are immutable at run-time. Parameters are defined by logic block type and are fed to the logic builder. Constraint planner parameters allow for specific selection and integration over known parameter records stored in the driver document passed to the logic block at call time.

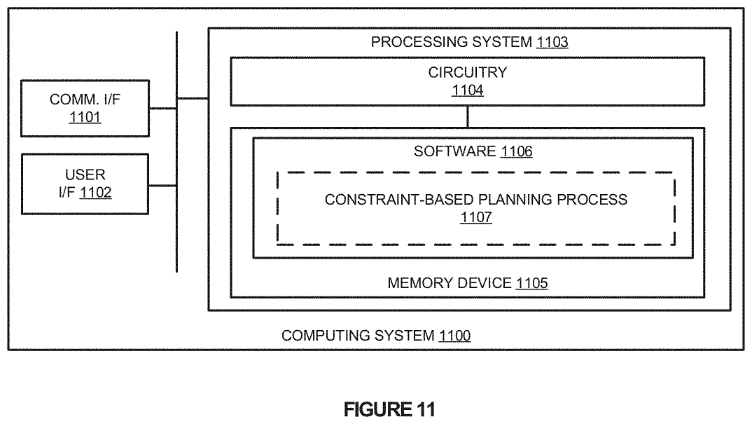

FIG. 11 illustrates computing system 1100 to perform constraint-based planning according to an implementation of the present technology. Computing system 1100 is representative of any computing system or collection of systems with which the various operational architectures, processes, scenarios, and sequences disclosed herein for constraint-based planning may be employed. Computing system 1100 may be implemented as a single apparatus, system, or device or may be implemented in a distributed manner as multiple apparatuses, systems, or devices.

Computing system 1100 comprises communication interface 1101, user interface 1102, and processing system 1103. Processing system 1103 is linked to communication interface 1101 and user interface 1102. Processing system 1103 includes processing circuitry 1104 and memory device 1105 that stores operating software 1106. Computing system 1100 may include other well-known components such as batteries and enclosures that are not shown in the present example for clarity. Examples of computing system 1100 include, but are not limited to, desktop computers, laptop computers, server computers, routers, web servers, cloud computing platforms, and data center equipment, as well as any other type of physical or virtual server machines, physical or virtual routers, containers, and any variation or combination thereof.

Processing system 1103 loads and executes software 1106 from memory device 1105. Software 1106 includes and implements constraint-based planning process 1107, which may be representative of the UI-side and server-side constraint-based planning processes discussed with respect to the preceding Figures. When executed by processing system 1103 to perform the processes described herein, software 1106 directs processing system 1103 to operate as described for at least the various processes, operational scenarios, and sequences discussed in the foregoing implementations. Computing system 1100 may optionally include additional devices, features, or functionality not discussed for purposes of brevity.

Referring still to FIG. 11, processing system 1103 may comprise a micro-processor and other circuitry that retrieves and executes software 1106 from memory device 1105. Processing system 1103 may be implemented within a single processing device but may also be distributed across multiple processing devices or sub-systems that cooperate in executing program instructions. Examples of processing system 1103 include general purpose central processing units, graphical processing units, application specific processors, and logic devices, as well as any other type of processing devices, combinations, or variations thereof.

User interface 1102 comprises components that interact with a user to receive user inputs and to present media and/or information. User interface 1102 may include a speaker, microphone, buttons, lights, display screen, touch screen, touch pad, scroll wheel, communication port, or some other user input/output apparatus, including combinations thereof. User interface 1102 may be omitted in some examples.

Memory device 1105 may comprise any computer-readable storage media readable by processing system 1103 and capable of storing software 1106. Memory device 1105 may include volatile and nonvolatile, removable and non-removable media implemented in any method or technology for storage of information, such as computer readable instructions, data structures, program modules, or other data. Examples of storage media include random access memory, read only memory, magnetic disks, optical disks, optical media, flash memory, virtual memory and non-virtual memory, magnetic cassettes, magnetic tape, magnetic disk storage or other magnetic storage devices, or any other suitable storage media. In no case is the computer-readable storage media a propagated signal.

In addition to computer-readable storage media, in some implementations memory device 1105 may also include computer-readable communication media over which at least some of software 1106 may be communicated internally or externally. Memory device 1105 may be implemented as a single storage device but may also be implemented across multiple storage devices or sub-systems co-located or distributed relative to each other. Memory device 1105 may comprise additional elements, such as a controller, capable of communicating with processing system 1103 or possibly other systems.

Software 1106 (including constraint-based planning process 1107) may be implemented in program instructions and among other functions may, when executed by processing system 1103, direct processing system 1103 to operate as described with respect to the various operational scenarios, sequences, and processes illustrated herein. For example, software 1106 may include program instructions for implementing a planner builder application, a logic block builder application, or a planner engine as described herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 1106 may include additional processes, programs, or components, such as operating system software, virtualization software, or other application software. Software 1106 may also comprise firmware or some other form of machine-readable processing instructions executable by processing system 1103.

In general, software 1106 may, when loaded into processing system 1103 and executed, transform a suitable apparatus, system, or device (of which computing system 1100 is representative) overall from a general-purpose computing system into a special-purpose computing system customized to provide a no-code development environment that includes constraint-based planner building processes as described herein. Indeed, encoding software 1106 on memory device 1105 may transform the physical structure of memory device 1105. The specific transformation of the physical structure may depend on various factors in different implementations of this description. Examples of such factors may include, but are not limited to, the technology used to implement the storage media of memory device 1105 and whether the computer-storage media are characterized as primary or secondary storage, as well as other factors.

For example, if the computer readable storage media are implemented as semiconductor-based memory, software 1106 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface 1101 may include communication connections and devices that allow for communication with other computing systems (not shown) over communication networks (not shown). Examples of connections and devices that together allow for inter-system communication may include network interface cards, ports, antennas, power amplifiers, radio frequency circuitry, transceivers, and other communication circuitry. The connections and devices may communicate over communication media to exchange communications with other computing systems or networks of systems, such as metal, glass, air, or any other suitable communication media. Communication interface 1101 may be configured to use Time Division Multiplex (TDM), Internet Protocol (IP), Ethernet, optical networking, wireless protocols, communication signaling, or some other communication format, including combinations thereof. The aforementioned media, connections, and devices are well known and need not be discussed at length here.

Communication between computing system 1100 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable medium(s) having computer readable program code embodied thereon.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The phrases “in some embodiments,” “according to some embodiments,” “in the embodiments shown,” “in other embodiments,” and the like generally mean the particular feature, structure, or characteristic following the phrase is included in at least one implementation of the present technology, and may be included in more than one implementation. In addition, such phrases do not necessarily refer to the same embodiments or different embodiments.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed or implemented in parallel or may be performed at different times. Further, any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

These and other changes can be made to the technology in light of the above Detailed Description. While the above description describes certain examples of the technology, no matter how detailed the above appears in text, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 112(f) will begin with the words “means for,” but use of the term “for” in any other context is not intended to invoke treatment under 35 U.S.C. § 112(f). Accordingly, the applicant reserves the right to pursue additional claims after filing this application to pursue such additional claim forms, in either this application or in a continuing application.

What is claimed is:

1. A method of operating a planner engine comprising:
in a computer, initiating the planner engine according to a planner definition, wherein the planner definition identifies a planning problem and includes metadata identifying one or more planning variables of the planning problem and one or more constraints related to the one or more planning variables;
in the computer, gathering data from a database specified by the planner definition;
in the computer, parsing the data into planning data based on the planner definition;
in the computer, conducting planning according to the planner definition using the planning data, wherein conducting the planning comprises creating one or more plans by solving the planning problem based on the one or more constraints related to the one or more planning variables;
in the computer, identifying a final plan from the one or more plans, wherein the final plan is identified based on how well the final plan satisfies the one or more constraints compared to at least one other plan of the one or more plans; and
in the computer, outputting the final plan.

2. The method of claim 1, wherein the planner definition further identifies at least one or more of a time constraint, optimal score, heuristic, algorithm, and logic block.

3. The method of claim 1, wherein outputting the final plan comprises calling a final logic block specified in the planner definition and passing a representation of final values for each planning variable of the one or more planning variables to the final logic block.

4. The method of claim 1, wherein conducting planning according to the planner definition using the planning data further comprises calculating a hard score, a medium score, and a soft score for at least one planning variable of the one or more planning variables and solving the planning problem based at least in part on the hard score, the medium, score, and the soft score for the at least one planning variable of the one or more planning variables.

5. The method of claim 1, wherein the computer is a server chosen based on computing requirements associated with the planner definition.

6. The method of claim 1, wherein:
conducting planning according to the planner definition using the planning data further comprises initiating a constraint solver in multiple threads according to a parallelization method specified in the planner definition; and
the multiple threads solve the planning problem in parallel.

7. The method of claim 1, wherein:
the planner definition is configured in a planner builder application; and
the planner builder application receives input from a user specifying data and requirements related to the planning problem.

8. A planner system comprising:
one or more computer-readable storage media;
a processing system operatively coupled with the one or more computer-readable storage media; and
program instructions, stored on the one or more computer-readable storage media for operating a planner engine, wherein the program instructions, when read and executed by the processing system, direct the processing system to at least:
in a computer, initiate the planner engine according to a planner definition, wherein the planner definition identifies a planning problem and includes metadata identifying one or more planning variables of the planning problem and one or more constraints related to the one or more planning variables;
in the computer, gather data from a database specified by the planner definition;
in the computer, parse the data into planning data based on the planner definition;
in the computer, conduct planning according to the planner definition using the planning data, wherein the planning comprises creating one or more plans by solving the planning problem based on the one or more constraints related to the one or more planning variables;
in the computer, identify a final plan from the one or more plans, wherein the final plan is identified based on how well the final plan satisfies the one or more constraints compared to at least one other plan of the one or more plans; and
in the computer, output the final plan.

9. The system of claim 8, wherein the planner definition further identifies at least one or more of a time constraint, optimal score, heuristic, algorithm, and logic block.

10. The system of claim 8, wherein directing the processing system to, in the computer, output the final plan comprises directing the processing system to, in the computer, call a final logic block specified in the planner definition and pass a representation of final values for each planning variable of the one or more planning variables to the final logic block.

11. The system of claim 8, wherein the planning further comprises calculating a hard score, a medium score, and a soft score for at least one planning variable of the one or more planning variables and solving the planning problem based at least in part on the hard score, the medium, score, and the soft score for the at least one planning variable of the one or more planning variables.

12. The system of claim 8, wherein the computer is a server chosen based on computing requirements associated with the planner definition.

13. The system of claim 8, wherein:
directing the processing system to conduct planning according to the planner definition using the planning data further comprises, in the computer, directing the processing system to initiate a constraint solver in multiple threads according to a parallelization method specified in the planner definition; and
the multiple threads solve the planning problem in parallel.

14. The system of claim 8, wherein:
the planner definition was configured in a planner builder application; and
the planner builder application receives input from a user specifying data and requirements related to the planning problem.

15. One or more computer-readable storage media having program instructions stored thereon for operating a planner engine, wherein the program instructions, when read and executed by a processing system, direct the processing system to:
in a computer, initiate the planner engine according to a planner definition, wherein the planner definition identifies a planning problem and includes metadata identifying one or more planning variables of the planning problem and one or more constraints related to the one or more planning variables; and
in the computer, gather data from a database specified by the planner definition;
in the computer, parse the data into planning data based on the planner definition;
in the computer, conduct planning according to the planner definition using the planning data, wherein the planning comprises creating one or more plans by solving the planning problem based on the one or more constraints related to the one or more planning variables;
in the computer, identify a final plan from the one or more plans, wherein the final plan is identified based on how well the final plan satisfies the one or more constraints compared to at least one other plan of the one or more plans; and
in the computer, output the final plan.

16. The one or more computer-readable storage media of claim 15, wherein the planner definition further identifies at least one or more of a time constraint, optimal score, heuristic, algorithm, and logic block.

17. The one or more computer-readable storage media of claim 15, wherein directing the processing system to, in the computer, output the final plan comprises directing the processing system to, in the computer, call a final logic block specified in the planner definition and pass a representation of final values for each planning variable of the one or more planning variables to the final logic block.

18. The one or more computer-readable storage media of claim 15, wherein the planning further comprises calculating a hard score, a medium score, and a soft score for at least one planning variable of the one or more planning variables and solving the planning problem based at least in part on the hard score, the medium, score, and the soft score for the at least one planning variable of the one or more planning variables.

19. The one or more computer-readable storage media of claim 15, wherein the computer is a server chosen based on computing requirements associated with the planner definition.

20. The system of claim 8, wherein:
directing the processing system to, in the computer, conduct planning according to the planner definition using the planning data further comprises directing the processing system to, in the computer, initiate a constraint solver in multiple threads according to a parallelization method specified in the planner definition; and
the multiple threads solve the planning problem in parallel.
